(19) United States
(12) Patent Application Publication
(10) Pub. No.: US 2007/0067230 A1
(43) Pub. Date: Mar. 22, 2007

(54) Method and structure for raising funding for a public company and financing the issuance of securities

(76) Inventors: Brooks Harris, New York, NY (US); Donald Sung, New York, NY (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/231,439

(22) Filed: Sep. 20, 2005

(51) Int. Cl. G06Q 40/00

(52) U.S. Cl. 705/36 R

(57) ABSTRACT

In a method and structure for raising funding for a public company through the issuance of a derivative-related security, placing the derivative-related security into at least a first public market. An underwriter borrows an amount of an issuer's shares at least one of prior to, in conjunction with, shortly after and sometime after the placing of the derivative-related security into the at least first public market. At least one of offering and selling the borrowed shares in at least one public market to create a short position. Transferring the short position to a purchaser of the derivative-related security.

### BACKGROUND OF THE INVENTION

There are many hurdles to overcome for a company attempting to raise capital though the public markets, including regulatory and market based. One such hurdle is the limitation on the size of the offering (i.e., number of securities) that can be made by a company, and is based on market factors. The financial markets impose certain limitations on the issuance of securities, such as, for example, equity-based derivatives, including certain types of debt offerings, offerings of bonds, notes, convertible notes, and other financial instruments.

The market for derivative-related securities, such as, for example, equity derivatives, including convertible bonds, is predominantly comprised of “hedge investors” who prefer to enter into risk ameliorating financial transactions in order to hedge their exposure to the value of assets underlying a derivative investment. In the case of an investment in convertible bonds, hedge investors that are long convertible bonds hedge their exposure to the stock underlying the convertible bonds by simultaneously entering into a short stock position.

A hedge investor traditionally enters into a short stock position by locating shares to borrow (“stock loan”), borrowing the shares at a given rate, and selling those shares short. The hedge investor pays an ongoing borrowing rate to the lender to maintain the short stock position.

Hedge investors looking to participate in new issuances of derivative-related securities, such as, for example, equity derivatives, including convertible securities, require the availability of sufficient stock to borrow, at a reasonable rate, so that they may engage in their short “hedge” transaction, in order to participate in the new issue offering. Without the ability to easily locate shares to short, hedge investors will be unable to hedge the long convertible bond position and, therefore are unwilling or not able to participate in the new convertible bond offering. Because hedge investors comprise the majority of the convertible market, their inability to participate adversely affects terms available to issuers, and in most cases prevents the successful placement of these types of offering to the market.

As a result, issuers who had insufficient stock availability for loans loan were excluded from the derivative-related securities markets, such as, for example, equity derivatives, including convertibles. Thus, these issuers have been unable to take full advantage of the new issuance of convertible securities, such as, for example, by issuing convertible securities in the full amount of or an amount greater than their existing debt.

### SUMMARY OF THE INVENTION

The present invention solves these problems by providing a method and structure for raising funding for a public company and financing the issuance of derivative-related securities, such as, for example, equity derivatives, through a borrow facility.

The present invention solves these problems by providing a method and structure for allowing issuers with insufficient stock loan availability to raise proceeds in the derivative-related securities market, such as, for example, the equity derivatives markets, including the convertible market, via a “stock loan facility.”

A method and structure for raising funding for a public company through the issuance of a derivative-related security, comprising: an underwriter placing the derivative-related security into a financial market on behalf of the issuer; prior to, in conjunction with, shortly after, or some time after the issuance of the securities, the underwriter borrows from the issuer an amount of the issuer's shares; the underwriter offers and/or sells the borrowed shares to equity investors in at least one public market to create a short position; the underwriter transfers the short position to derivative-related securities investors.

The present invention also teaches a method and structure for raising funding for a public company through the issuance of a derivative-related security, wherein the derivative-related security is a convertible bond.

The present invention also teaches a method and structure for raising funding for a public company through the issuance of a derivative-related security, wherein the registered shares are registered with the U.S. Securities and Exchange Commission.

The present invention also teaches a method and structure for raising funding for a public company through the issuance of a derivative-related security, wherein the short position is transferred to the derivative-related securities investors using a synthetic swap.

The present invention also teaches a method and structure for raising funding for a public company through the issuance of a derivative-related security, wherein the synthetic swap includes the derivative-related securities investor entering into a total return swap with the underwriter which transfers the economics of the short position from the underwriter to the derivative-related securities investor.

The present invention also teaches a method and structure for raising funding for a public company through the issuance of a derivative-related security, wherein the short position is transferred to the derivative-related securities investors using a physical short.

The present invention also teaches a method and structure for raising funding for a public company through the issuance of a derivative-related security, wherein the physical short includes the underwriter borrowing additional registered shares from the issuer, and entering into at least one transaction to transfer the short position to the derivative-related securities investors.

The present invention also teaches a method and structure for raising funding for a public company through the issuance of a derivative-related security, wherein the physical short comprises: the underwriter borrowing additional registered shares from the issuer equal to a percentage of the number of registered shares previously borrowed by the underwriter from the issuer and sold to equity investors; the underwriter lending newly borrowed registered shares to hedge a first derivative-related securities investor; the first derivative-related securities investor selling the newly borrowed registered shares back to the underwriter to establish a first short position; the underwriter re-lending the newly borrowed registered shares purchased from the first derivative-related securities investor to a second derivative-related securities investor; the second derivative-related securities investor selling the newly borrowed registered shares back to the underwriter to establish a second short position.

This process may continue until all investors are hedged and the underwriter short position has been eliminated through the series of repurchases.

The present invention also teaches a method and structure for raising funding for a public company through the issuance of a derivative-related security, wherein the percentage of additional shares borrowed is approximately 1% to 50% of the number of registered shares previously borrowed by the underwriter from the issuer and sold to equity investors.

An embodiment of the present invention may be structured and operated in the following way: Much like a traditional convertible offering, the underwriter places a convertible into the market on behalf of the issuer. Prior to, in conjunction with, shortly after, or some time after the issuance of the securities, the issuer lends the underwriter an amount of the issuer's SEC-registered shares. The underwriter then offers and/or sells the borrowed shares to equity investors in the public markets. This provides the underwriter with a short position in the underlying equity in an amount equal to the amount sold to the equity market. The underwriter may then “transfer” this short position to convertible investors in one of two ways. The first way is through a synthetic swap, where investors enter into a total return swap with the underwriter which transfers the economics of the short stock position from the underwriter to the investor. The second way is through a physical short, where the underwriter borrows a small amount of additional shares from the issuer, and enters into a series of transactions to transfer the short position to convertible investors.

In the case of the physical short, it may be accomplished as follows: The underwriter borrows additional shares from the issuer equal to a percentage, such as, for example, approximately 1% to 50%, of the number of shares previously borrowed and sold to equity investors. The underwriter lends the newly borrowed shares to Hedge Investor A. Hedge Investor A sells the newly borrowed shares back to the underwriter to establish a short position for Hedge Investor A. The underwriter re-lends the purchased newly borrowed shares to Hedge Investor B. Hedge Investor B sells the newly borrowed shares back to the underwriter to establish a short position for Hedge Investor B. This process may continue until all Hedge Investors are hedged and the underwriter short position has been eliminated through the series of repurchases.

The shares lent by the issuer to the underwriter for this purpose are not considered issued from the perspective of the accounting treatment accorded to such stock and, accordingly, are unlikely to cause an economic dilution to the issuer's stock as a result.

Certain limitations may be placed on the loan of the issuer stock, such as, for example, that the underwriter may only use the borrowed stock for purposes of directly or indirectly facilitating the sale of the convertible notes and the hedging of the convertible notes by purchasers of the convertible notes.

The loan of shares to the underwriter may be structured such that the loan will terminate under certain conditions, including, for example, at the discretion of the underwriter, upon default or breach by the underwriter of the agreement relating to the lending of the shares, if the issuer enters into a merger or similar business combination transaction.

The loan of shares may also be structured such that for any shares that are issued upon conversion of the convertible notes, an equal number of borrowed shares must be returned to the issuer. An additional restriction on the borrowed shares may be that upon return the borrowed shares may not be re-borrowed.

As described above, any shares that are loaned to the underwriter will be issued and outstanding for corporate law purposes, thereby providing the holders of the borrowed shares all of the rights of a holder of the issuer's outstanding shares, including the right to vote the shares on all matters submitted to a vote of the stockholders and the right to receive any dividends or other distributions that the issuer may pay or make on its outstanding shares of common stock.

To minimize any potential adverse impact of these factors, the issuer and the underwriter may enter into agreement, among other things, to pay to the issuer an amount equal to any cash dividends that the issuer pays on the borrowed shares, to pay or deliver to the issuer any other distribution, in liquidation or otherwise, that the issuer may make of the borrowed shares, and to transfer its right to vote its shares to a designated entity or individual.

The issuer may also require that the underwriter post and maintain collateral, such as, for example, in the form of cash, government securities, certificates of deposit, high grade commercial paper of U.S. or foreign issuers, money market shares or some other valuable asset of the underwriter or guarantor of the underwriter. This collateral can represent one hundred percent or less of the borrowed shares, and will be held as security for the obligation of the underwriter to return the borrowed shares of common stock to the issuer as previously agreed or pursuant to the specific terms of the borrow facility. In the event that the shares are not returned, the issuer may receive a distribution of the posted collateral in lieu of the delivery of the borrowed shares.

These obligations of the underwriter will mitigate or substantially eliminate the economic dilution that would otherwise result from the issuance of the borrowed shares. Additionally, the borrowed shares are not likely, under U.S. generally accepted accounting principles (GAAP) currently in effect, to be considered outstanding for the purpose of computing and reporting the issuer's earnings per share.

The amount of the issuance, i.e., the total number of derivative-related securities which may be offered by the issuer, is determined by the number of shares of the issuer's stock available in the market and the “delta” of the derivative-related security. The “delta” denotes how sensitive the price of the security is to a $1.00 change in the underlying stock price. However, prior to, in conjunction with, shortly after, or some time after the issuance of the securities the issuer loans and the underwriter borrows an amount of the issuer's registered stock that would provide availability of an adequate number of shares of registered stock in the market so as to allow the issuer to issue the desired amount of derivative-related securities. The underwriter then offers and/or sells the outstanding issuer stock to equity investors in the public markets at the same time that the underwriter offers the derivative-related securities, such as, for example, the convertible notes to investors. Additionally, the underwriter offers the derivative-related securities investors the borrowed registered stock to be used to short sell as a hedge against the purchased securities. Although it is not planned for this borrowed stock to leave the underwriter's control, it is nevertheless considered available from the perspective of the markets for purposes of calculating the quantity of available issuer stock so that the amount of derivative-related securities being issued may be greater than otherwise possible.

The derivative-related security being offered to raise funding for the issuer may be in any form, such as for example, in the form of a convertible note or bond having a coupon, a contingent convertible note or some other financial instrument. Additionally, the conversion could be offered at a premium of any amount that the market could bear. The coupon could be collateralized, for example, by purchasing treasuries or some other stable and/or fixed income investment instrument

The investors in the issuer's derivative-related securities being offered through the underwriter have the opportunity to short the issuer stock in order to hedge against their risk in investing in and holding the issuer's derivative related securities. This may be accomplished by short selling against the stock being held by the underwriter who will cover any of the short sales by investors. The borrowing of the stock by the underwriter may be cost free or there may be a charge for the loan of such stock by the issuer.

### BRIEF DESCRIPTION OF THE DRAWINGS

FIG. 1 shows a diagram of a stock loan transaction according to an embodiment of the present invention.

FIG. 2 shows a diagram of a convertible sale, an equity sale, a stock loan and a hedging transaction using a synthetic short according to an embodiment of the present invention.

FIG. 3 shows a diagram of a convertible sale, an equity sale, a stock loan and a hedging transaction using a physical short according to an embodiment of the present invention.

FIG. 4 shows a flow diagram of a method for accomplishing a convertible sale, an equity sale, a stock loan, and a hedging transaction according to an embodiment of the present invention.

### DETAILED DESCRIPTION

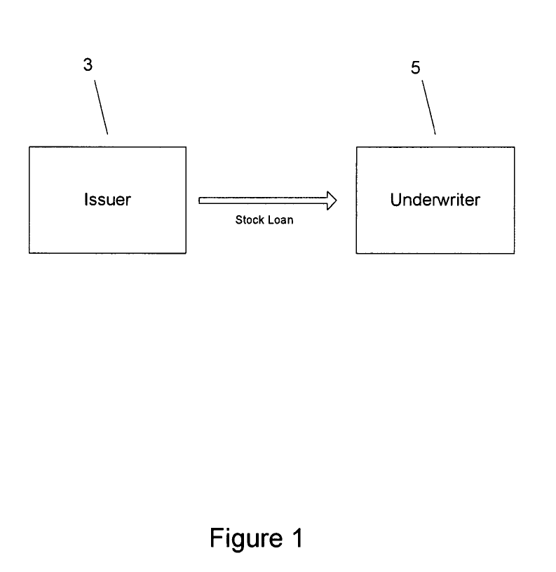

In FIG. 1 there is shown a diagram of a stock loan transaction according to an embodiment of the present invention. The issuer 3 loans the underwriter 5 a predetermined number of shares of issuer registered stock, which in this case is in the form of unissued shares. The underwriter 5 is contractually obligated to return those shares after a predetermined period of time. The underwriter 5 borrows these shares interest free. These shares may be used to cover any short sales of the issuer stock provided that the underwriter 5 does not transfer physical control of the shares to another party. Alternatively, there may be a fee imposed by the issuer 3 for the borrowing of these shares by the underwriter 5.

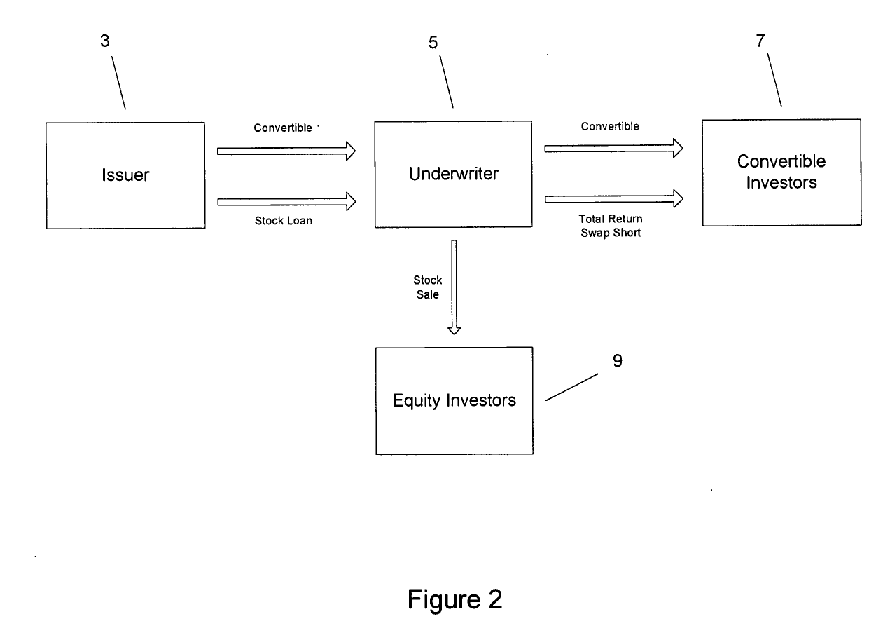

Looking now at FIG. 2, there is shown a diagram of a convertible sale, an equity sale, a stock loan and a hedging transaction using a synthetic short according to an embodiment of the present invention. The issuer 3 issues convertible notes to be sold to convertible investors 7 through the underwriter 5 and loans the underwriter 5 issuer stock. The convertible investors 7 purchase the convertible notes and short issuer stock via a total return swap. The swap offsets the underwriter's existing short position from the sale of borrowed issuer stock to equity investors 9.

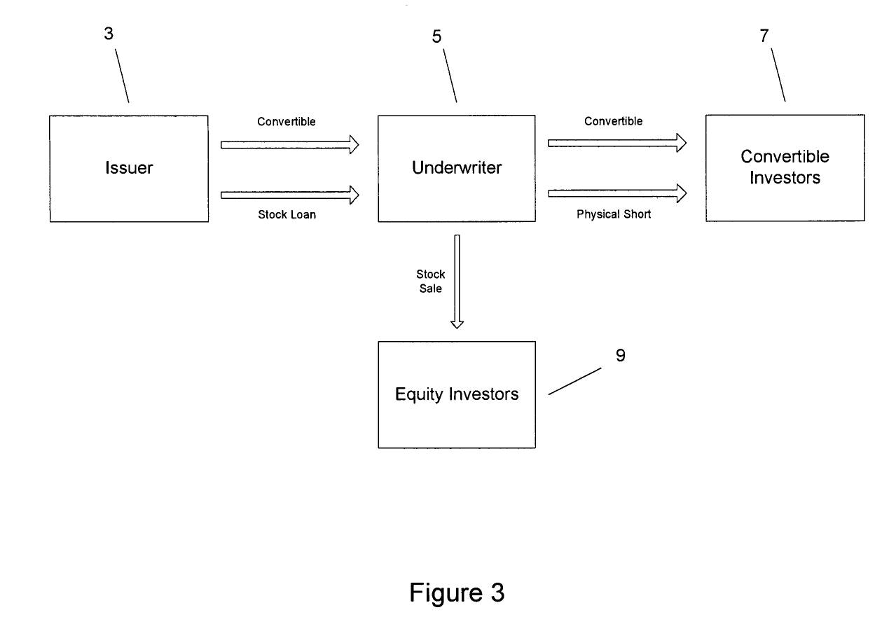

In FIG. 3 there is shown a diagram of a convertible sale, an equity sale, a stock loan, and a hedging transaction using a physical short according to an embodiment of the present invention. As shown in FIG. 3, the issuer 3 issues convertible notes to be sold to convertible investors 7 through the underwriter 5 and loans the underwriter 5 issuer stock. The convertible investors 7 purchase the convertible notes and short issuer stock to underwriter 5 via a physical short. The stock purchased by the underwriter 5 offsets the existing short position of underwriter 5 from the sale of borrowed issuer 3 stock to equity investors 9.

The shares that are borrowed by the underwriter 5 may be provided by the issuer 3 without cost to the underwriter 5 or may be provided for a loan fee. For example, the issuer may charge a nominal amount, such as, $0.001 per share borrowed or the issuer may provide the shares for a higher fee per share. The shares may be made available during a fixed period of time, such as, for example, for a period of ten years from the date the shares are first made available for borrowing and may remain available for the fixed period or less time should certain conditions occur. For example, the stock may be made no longer available should the entire principal amount of the convertible notes cease to be outstanding as a result of conversion, repurchase or redemption.

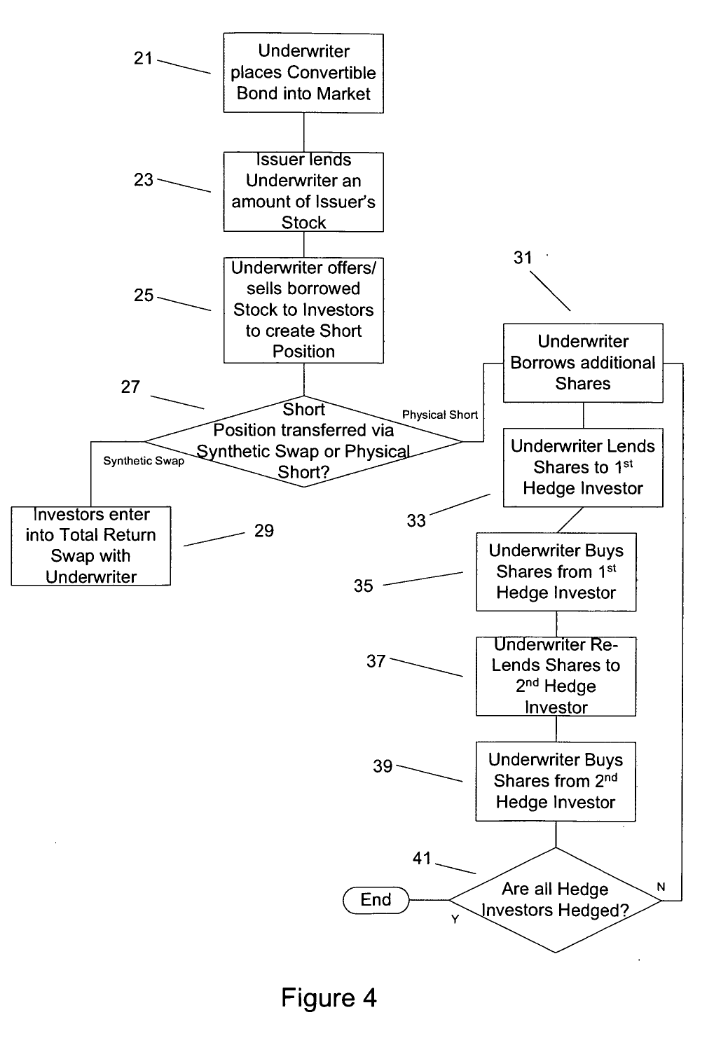

Looking now at FIG. 4, there is shown a flow diagram of a method for accomplishing a convertible sale, an equity sale, a stock loan, and a hedging transaction according to an embodiment of the present invention. In step 21, the underwriter 5 places a convertible bond into the convertible bond market on behalf of the issuer 3. In step 23, the issuer 3 lends the underwriter 5 an amount of the issuer's 3 SEC-registered shares either prior to, in conjunction with, shortly after or some time after the issuance of the convertible bond. In step 25, the underwriter 5 offers and/or sells the borrowed SEC-registered shares to equity investors in the public equities markets. This provides the underwriter 5 with a short position in the underlying equity, i.e., the issuer's stock, in an amount equal to the amount of the issuer's stock sold to the public equity markets. In step 27, the underwriter 5 determines whether the short position will be transferred to convertible investors either through a synthetic swap or a physical short. If a synthetic swap is chosen, then in step 29, the investors 7 enter into a total return swap with the underwriter 5, which transfers the economics of the short position from the underwriter 5 to the investors 7.

If a physical short is selected, then in step 31, the underwriter borrows additional shares from the issuer equal to 1% to 50% of the number of shares previously borrowed by the underwriter 5 and sold to investors 7. In step 33, the underwriter 5 lends the newly borrowed shares to a first hedge investor. In step 35, the first hedge investor sells the borrowed shares back to the underwriter 5 to establish a short position for the first hedge investor. In step 37, the underwriter 5 re-lends the purchased borrowed shares to a second hedge investor. In step 39, the second hedge investor sells the borrowed shares back to the underwriter 5 to establish a short position for the second hedge investor. In step 41, a determination is made as to whether all hedge investors are hedged and whether the underwriter's short position has been eliminated through the series of repurchases by the underwriter 5 of the borrowed shares. If it is determined that all hedge investors are not hedged, the process returns to step 31. If all hedge investors are hedged then the process ends.

What is claimed is:

1. A method for raising funding for a public company through the issuance of a derivative-related security, comprising:
placing the derivative-related security into at least a first public market;
an underwriter borrowing an amount of an issuer's shares at least one of prior to, in conjunction with, shortly after and sometime after the placing of the derivative-related security;
at least one of offering and selling the borrowed shares in at least one public market to create a short position;
transferring the short position to a purchaser of the derivative-related security.

2. The method according to claim 1, wherein the transfer of the short position to a purchaser of the derivative-related security is accomplished by transferring the economics of the short position to the purchaser of the derivative-related security.

3. The method according to claim 2, wherein the economics of the short position are transferred to the purchaser of the derivative-related security by a synthetic swap.

4. The method according to claim 3, wherein the synthetic swap is a total return swap.

5. The method according to claim 2, wherein the economics of the short position are transferred to the purchaser of the derivative-related security by a physical short.

6. The method according to claim 1, wherein the transferring of the short position to the purchaser of the derivative-related security comprises:
the underwriter borrowing additional shares from the issuer equal to a percentage of the shares previously borrowed and sold to equity investors;
the underwriter lending the additional shares to a first hedge investor;
the underwriter purchasing the loaned additional shares from the first hedge investor to establish a short position for the first hedge investor.

7. The method according to claim 6, further comprising:
the underwriter lending the re-purchased additional shares to a second hedge investor;
the underwriter purchasing the loaned re-purchased additional shares from the second hedge investor to establish a short position for the second hedge investor.

8. The method according to claim 1, wherein the derivative-related security is a convertible bond.

9. The method according to claim 1, wherein the at least a first public market is a fixed income market.

10. The method according to claim 1, wherein the at least a second public market is an equities market.

11. The method according to claim 1, wherein the purchaser of the derivative-related security is a hedge investor.

12. A method for raising funding for a public company through the issuance of a derivative-related security, comprising:
placing the derivative-related security into at least one public market;
an issuer lending an amount of the issuer's shares to an underwriter at least one of prior to, in conjunction with, shortly after and sometime after the placing of the derivative-related security;
the underwriter at least one of offering and selling the borrowed shares in at least one public market to create a short position;
transferring the short position to a purchaser of the derivative-related security.

13. The method according to claim 12, wherein the transfer of the short position to a purchaser of the derivative-related security is accomplished by transferring the economics of the short position to the purchaser of the derivative-related security.

14. The method according to claim 13, wherein the economics of the short position are transferred to the purchaser of the derivative-related security by a synthetic swap.

15. The method according to claim 14, wherein the synthetic swap is a total return swap.

16. The method according to claim 13, wherein the economics of the short position are transferred to the purchaser of the derivative-related security by a physical short.

17. The method according to claim 12, wherein the transferring of the short position to the purchaser of the derivative-related security comprises:
the issuer lending additional shares to the underwriter equal to a percentage of the shares previously lent and sold to equity investors;
the underwriter lending the additional shares to a first hedge investor;
the underwriter purchasing the loaned additional shares from the first hedge investor to establish a short position for the first hedge investor.

18. The method according to claim 17, further comprising:
the underwriter lending the re-purchased additional shares to a second hedge investor;
the underwriter purchasing the loaned re-purchased additional shares from the second hedge investor to establish a short position for the second hedge investor.

19. The method according to claim 12, wherein the derivative-related security is a convertible bond.

20. The method according to claim 12, wherein the at least a first public market is a fixed income market.

21. The method according to claim 12, wherein the at least a second public market is an equities market.

22. The method according to claim 12, wherein the purchaser of the derivative-related security is a hedge investor.

23. A structure for raising funding for a public company through the issuance of a derivative-related security, comprising:
entering into a first agreement with an underwriter to place a derivative-related security into at least one public market;
entering into a second agreement with the underwriter for the borrowing of an amount of an issuer's shares at least one of prior to, in conjunction with, shortly after and sometime after the placing of the derivative-related security;
entering into a third agreement to sell the borrowed shares in at least one public market to create a short position;
entering into an agreement to transfer the short position to a purchaser of the derivative-related security.

24. A structure for raising funding for a public company through the issuance of a derivative-related security, comprising:
entering into a first agreement with an issuer to place a derivative-related security into at least one public market;
entering into a second agreement with the issuer for the lending of an amount of an issuer's shares at least one of prior to, in conjunction with, shortly after and sometime after the placing of the derivative-related security;
entering into a third agreement with an investor to sell the loaned shares in at least one public market to create a short position;
entering into an agreement with a purchaser of the derivative-related security to transfer the short position to the purchaser of the derivative-related security.

25. A structure for raising funding for a public company through the issuance of a derivative-related security, comprising:
underwriting a derivative-related security offering;
establishing a borrow facility for issuer shares;
creating a short position for issuer shares;
entering into a short position exchange with a derivative-related security purchaser.

26. The structure according to claim 25, wherein the short position exchange is accomplished with a synthetic swap.

27. The structure according to claim 26, wherein the synthetic swap comprises a total return swap.

28. The structure according to claim 25, wherein the short position exchange is accomplished with a physical short.

29. The structure according to claim 28, wherein the physical short comprises:
entering into a loan agreement with the derivative-related security purchaser; and
purchasing loaned shares from the derivative-related security purchaser.
